(19) United States
(12) Patent Application Publication
(10) Pub. No.: US 2026/0058405 A1
(43) Pub. Date: Feb. 26, 2026

(54) MAGNETIC CONNECTION STRUCTURE FOR COMPUTER COOLING FAN ACCESS LINE

(71) Applicant: Guangzhou Huaqi Information Technology Co., Ltd., Guangzhou (CN)

(72) Inventor: Guodong YANG, Nanjing (CN)

(73) Assignee: Guangzhou Huaqi Information Technology Co., Ltd., Guangzhou (CN)

(21) Appl. No.: 18/809,425

(22) Filed: Aug. 20, 2024

(51) Int. Cl. H01R 13/62; G06F 1/20; H01R 12/70; H01R 12/77

(52) U.S. Cl. CPC H01R 13/6205; H01R 12/7088; H01R 12/77; G06F 1/20

(57) ABSTRACT

The disclosure belongs to the technical field of computer cooling components, and in particular to a magnetic connection structure for a computer cooling fan access line. Upper and lower sides of a power supply control magnetic line are provided with magnetic fixing assemblies. An inside of each embedding groove is connected with a movable magnet slider through a spring, and a top end of the movable magnet slider is connected with one pair of insertion lugs. The movable magnet slider and a spherical magnetic block are attached to each other, so that the insertion lugs are inserted into insertion sliding slots to achieve limiting and fixation. Limiting lugs capable of slightly expanding and retracting along with magnets are additionally provided on a power supply base and connected to limiting insertion slots, which improves stability of magnetic fixation of a power connector and avoids problems of disconnection, mismatch and poor connection.

### TECHNICAL FIELD

The disclosure belongs to the technical field of computer cooling component connection, and in particular to a magnetic connection structure for a computer cooling fan access line.

### BACKGROUND

With the upgrading of computer hardware, the working frequency of the computer hardware (graphics card, CPU) becomes increasingly higher. Typically, a plurality of individual fans may be connected in series through wires or interfaces of individual fans may be respectively connected to a power source, such that the fans are connected side by side, or they may be further mounted to a water cooling radiator, so as to achieve heat dissipation. This structure leads to excessive and messy wiring connections inside the computer, which easily leads to unstable operation of the fans. Moreover, this structure cannot be configured according to the user's requirements, thus having great limitations.

Therefore, magnetically connected computer cooling fans are generated, which use magnetic assemblies and conductive terminals instead of traditional wiring, thereby avoiding the problem of excessive and messy wiring connections. The magnetically connected cooling fans are typically fixed to the radiator or the case through bolts, so they cannot become disconnected due to shakes. However, the magnetic access bus is not fixed, and it is only connected magnetically, which easily leads to mismatch and poor connection between the magnetic access bus and the fan in case of transportation or shakes in daily life.

### SUMMARY

In order to overcome the defects and deficiencies in the prior art, an objective of the disclosure is to provide a magnetic connection structure for a computer cooling fan access line, which is simple in structure, reasonable in design and convenient to use. The magnetic connection structure for a computer cooling fan access line is an improvement based on the traditional magnetic seat structure for computer cooling fans. Limiting lugs capable of slightly expanding and retracting along with magnets are additionally provided on a power supply base and connected to limiting insertion slots, which improves stability of magnetic fixation of a power connector and avoids problems of disconnection, and mismatch and poor connection of terminals due to shakes.

In order to achieve the above objective, the disclosure adopts the following technical solution: the magnetic connection structure for a computer cooling fan access line includes cooling fans, magnetic terminal seats and a power supply control magnetic line. The adjacent cooling fans are magnetically connected through magnetic terminal seats, and the magnetic terminal seat on a left side of the cooling fan at an end is connected with the power supply control magnetic line. The magnetic terminal seats each include spherical magnetic blocks, insertion sliding slots and electrical terminals. The spherical magnetic blocks are embedded at upper and lower ends of the magnetic terminal seat, and two sides of each spherical magnetic block are symmetrically provided with one pair of insertion sliding slots. Upper and lower sides of the power supply control magnetic line are provided with magnetic fixing assemblies. Each magnetic fixing assembly includes an embedding groove, a spring, a movable magnet slider and insertion lugs. An inside of the embedding groove is connected with the movable magnet slider through the spring, and a top end of the movable magnet slider is connected with one pair of insertion lugs. The movable magnet slider and the spherical magnetic block are attached to each other, so that the insertion lugs are inserted into the insertion sliding slots to achieve limiting and fixation.

Preferably, an outer surface of the movable magnet slider is provided with a concave arc, and the concave arc keeps corresponding to the spherical magnetic block.

Preferably, an inner edge of the sliding slot keeps tangent to the spherical magnetic block to form a non-resistance guide structure; and an outer vertex of the spherical magnetic block keeps flush with an outer contour of the cooling fan.

Preferably, the sliding slots are distributed left and right with the spherical magnetic block as a center.

Preferably, the magnetic terminal seat keeps corresponding to the electrical terminal in a middle of the power supply control magnetic line.

By adopting the above structure, the disclosure has the following beneficial effects: the magnetic connection structure for a computer cooling fan access line is an improvement based on the traditional magnetic seat structure for computer cooling fans. Limiting lugs capable of slightly expanding and retracting along with magnets are additionally provided on a power supply base and connected to limiting insertion slots, which improves stability of magnetic fixation of a power connector and avoids problems of disconnection, and mismatch and poor connection of terminals due to shakes.

### BRIEF DESCRIPTION OF DRAWINGS

In order to more clearly explain the embodiments of the disclosure or the technical solutions in the prior art, the disclosure will be described in detail by the following specific implementations and the accompanying drawings.

FIG. 1 is a schematic structural view of the disclosure;

FIG. 2 is a schematic view showing the connection of a power supply control magnetic line 3 according to the disclosure;

FIG. 3 is a schematic view of the power supply control magnetic line 3 in a limited connected state according to the disclosure;

FIG. 4 is a schematic view of the disclosure in a disconnected state; and

FIG. 5 is a schematic structural view of a magnetic terminal seat 2 according to the disclosure.

Description of reference signs: cooling fan 1, magnetic terminal seat 2, power supply control magnetic line 3, spherical magnetic block 21, insertion sliding slot 22, electrical terminal 23, embedding groove 41, spring 42, movable magnet slider 43, insertion lug 44, concave arc 45.

### DETAILED DESCRIPTION OF THE EMBODIMENTS

In order to make the objectives, technical solutions and advantages of the disclosure clearer, the disclosure will be described through specific embodiments shown in the accompanying drawings. However, it should be understood that these descriptions are merely exemplary, and are not intended to limit the scope of the disclosure. In addition, in the following description, descriptions of well-known structures and technologies are omitted to avoid unnecessary confusion with the concepts of the disclosure.

Here, it should also be noted that in order to avoid obscuring the disclosure with unnecessary details, only the structures and/or processing steps closely related to the solutions according to the disclosure are shown in the accompanying drawings, and other details that are not related to the disclosure are omitted.

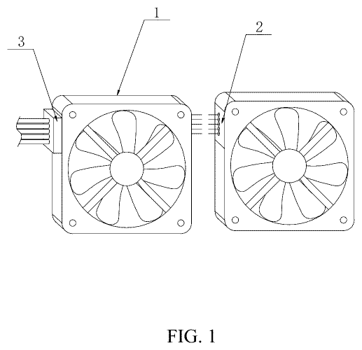

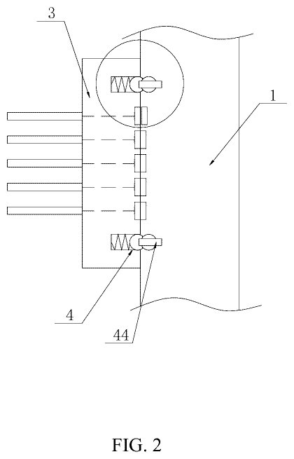

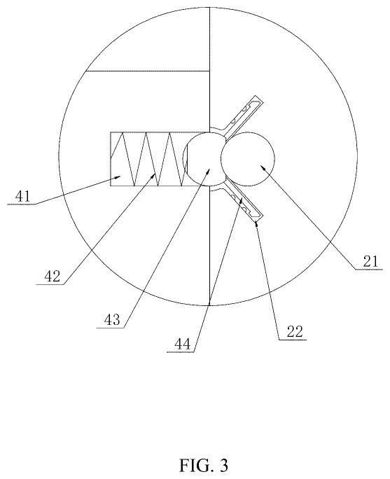

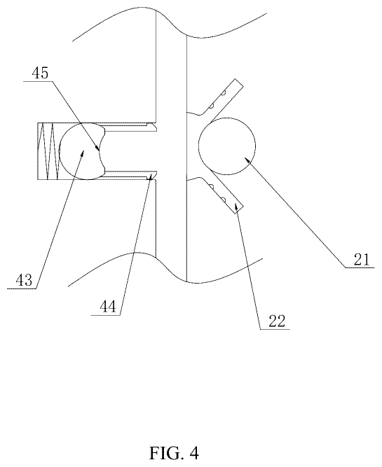

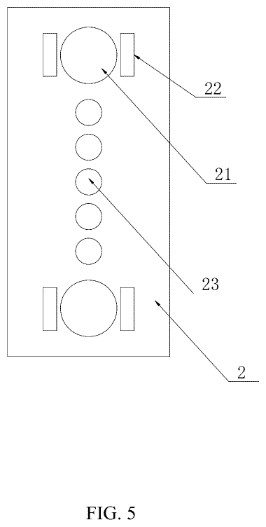

Referring to FIG. 1 to FIG. 5, this specific implementation adopts the following technical solution: a magnetic connection structure for a computer cooling fan access line includes cooling fans 1, magnetic terminal seats 2 and a power supply control magnetic line 3. The adjacent cooling fans 1 are magnetically connected through magnetic terminal seats 2, and the magnetic terminal seat 2 on a left side of the cooling fan 1 at an end is connected with the power supply control magnetic line 3. The magnetic terminal seats 2 each include spherical magnetic blocks 21, insertion sliding slots 22 and electrical terminals 23. The spherical magnetic blocks 2 are embedded at upper and lower ends of the magnetic terminal seat 21, and two sides of each spherical magnetic block 21 are symmetrically provided with one pair of insertion sliding slots 22. Upper and lower sides of the power supply control magnetic line 3 are provided with magnetic fixing assemblies 4. Each magnetic fixing assembly 4 includes an embedding groove 41, a spring 42, a movable magnet slider 43 and insertion lugs 44. An inside of the embedding groove 41 is connected with the movable magnet slider 43 through the spring 42, and a top end of the movable magnet slider 43 is connected with one pair of insertion lugs 44. The movable magnet slider 43 and the spherical magnetic block 21 are attached to each other, so that the insertion lugs 44 are inserted into the insertion sliding slots 22 to achieve limiting and fixation.

An outer surface of the movable magnet slider 43 is provided with a concave arc 45, and the concave arc 45 keeps corresponding to the spherical magnetic block 21. An inner edge of the sliding slot 22 keeps tangent to the spherical magnetic block 21 to form a non-resistance guide structure; and an outer vertex of the spherical magnetic block 21 keeps flush with an outer contour of the cooling fan 1. The sliding slots 22 are distributed left and right with the spherical magnetic block 21 as a center.

In addition, the magnetic terminal seat 2 keeps corresponding to the electrical terminal 23 in a middle of the power supply control magnetic line 3. The adjacent cooling fans 1 are attached and fixed to each other through the spherical magnetic blocks 21 at the two ends of the magnetic terminal seat 2, and fixed to a radiator through bolts.

The working principle of this specific implementation is as follows: when the power supply control magnetic line 3 is connected to the magnetic terminal seat 2, the movable magnet slider 43 and the spherical magnetic block 21 attract each other, and the movable magnet slider 43 moves outward along the embedding groove 41 to be attached to the spherical magnetic block 21. During the movement of the movable magnet slider 43, the insertion lugs 44 extend out of the embedding groove 41, come into contact with the spherical magnetic block 21, and then are automatically inserted into the sliding slots 22. The cooperation between the insertion lugs 44 and the sliding slots 22 can limit the movement of the power supply control magnetic line 3, thereby preventing the power supply control magnetic line from coming off due to shakes. After the movable magnet slider 43 becomes not magnetically attached, the spring 42 pulls the movable magnet slider 43 and drives the insertion lugs 44 to retract.

By adopting the above structure, this specific implementation has the following beneficial effects: the magnetic connection structure for a computer cooling fan access line is an improvement based on the traditional magnetic seat structure for computer cooling fans. Limiting lugs capable of slightly expanding and retracting along with magnets are additionally provided on a power supply base and connected to limiting insertion slots, which improves stability of magnetic fixation of a power connector and avoids problems of disconnection, and mismatch and poor connection of terminals due to shakes.

For those skilled in the art, it is apparent that the disclosure is not limited to the details of the above exemplary embodiments, and the disclosure can be implemented in other specific forms without departing from the spirit or basic features of the disclosure. Therefore, from any point of view, the embodiments should be regarded as exemplary and non-limiting. The scope of the disclosure is defined by the appended claims rather than the description above, and therefore, it is intended that all changes falling within the meaning and scope of equivalent elements of the claims are included in the disclosure.

In addition, it should be understood that although this specification is described according to the implementations, not every implementation contains only one independent technical solution, and this specification described in such a manner is only for the sake of clarity. Those skilled in the art in addition should take the specification as a whole, and the technical solutions in the embodiments can also be appropriately combined to form other implementations that can be understood by those skilled in the art.

What is claimed is:

1. A magnetic connection structure for a computer cooling fan access line, comprising cooling fans, magnetic terminal seats and a power supply control magnetic line, wherein the adjacent cooling fans are magnetically connected through magnetic terminal seats, and the magnetic terminal seat on a left side of the cooling fan at an end is connected with the power supply control magnetic line; the magnetic terminal seats each comprise spherical magnetic blocks, insertion sliding slots and electrical terminals, the spherical magnetic blocks being embedded at upper and lower ends of the magnetic terminal seat, and two sides of each spherical magnetic block being symmetrically provided with one pair of insertion sliding slots; upper and lower sides of the power supply control magnetic line are provided with magnetic fixing assemblies; each magnetic fixing assembly comprises an embedding groove, a spring, a movable magnet slider and insertion lugs, an inside of the embedding groove being connected with the movable magnet slider through the spring, and a top end of the movable magnet slider being connected with one pair of insertion lugs; and the movable magnet slider and the spherical magnetic block are attached to each other, so that the insertion lugs are inserted into the insertion sliding slots to achieve limiting and fixation.

2. The magnetic connection structure for a computer cooling fan access line according to claim 1, wherein an outer surface of the movable magnet slider is provided with a concave arc, and the concave arc keeps corresponding to the spherical magnetic block.

3. The magnetic connection structure for a computer cooling fan access line according to claim 1, wherein an inner edge of the sliding slot keeps tangent to the spherical magnetic block to form a non-resistance guide structure, and an outer vertex of the spherical magnetic block keeps flush with an outer contour of the cooling fan.

4. The magnetic connection structure for a computer cooling fan access line according to claim 1, wherein the sliding slots are distributed left and right with the spherical magnetic block as a center.

5. The magnetic connection structure for a computer cooling fan access line according to claim 1, wherein the magnetic terminal seat keeps corresponding to the electrical terminal in a middle of the power supply control magnetic line.
